(19) United States
(12) Patent Application Publication
(10) Pub. No.: US 2009/0314201 A1
(43) Pub. Date: Dec. 24, 2009

(54) ACCURATE CONVEYANCE SYSTEM USEFUL FOR SCREEN PRINTING

(76) Inventor: Andrea Baccini, Treviso (IT)

Correspondence Address: PATTERSON & SHERIDAN, LLP - - APPM/TX, 3040 POST OAK BOULEVARD, SUITE 1500, HOUSTON, TX, 77056, US

(21) Appl. No.: 12/257,159

(22) Filed: Oct. 23, 2008

(30) Foreign Application Priority Data
Jun. 19, 2008 (IT) IT UD2008A000141

(51) Int. Cl. B05C 11/00; B05C 13/00; B05C 17/08

(52) U.S. Cl. 118/500; 118/708; 101/126

(57) ABSTRACT

The present invention(s) provide an apparatus and method for processing substrates in a screen printing chamber that can deliver a repeatable and accurate screen printed pattern on one or more processed substrates. In one embodiment, the screen printing chamber is adapted to perform a screen printing process within a portion of a crystalline silicon solar cell production line in which a substrate is patterned with a desired material. In one embodiment, the screen printing chamber is a processing chamber positioned within the Rotary line tool or Softline™ tool available from Baccini S.p.A., which is owned by Applied Materials, Inc. of Santa Clara, Calif.

### CROSS-REFERENCE TO RELATED APPLICATIONS

This application claims priority to the Italian Patent Application Serial No. IT UD2008A000141, filed Jun. 19, 2008, [Attorney Docket No. APPM/013565 ITAL], entitled “ACCURATE CONVEYANCE SYSTEM USEFUL FOR SCREEN PRINTING”, which is herein incorporated by reference.

### BACKGROUND OF THE DISCLOSURE

1. Field of the Invention

The present invention relates to a system used to deposit a patterned layer on a surface of a substrate, such as a screen printing process.

2. Description of the Background Art

Solar cells are photovoltaic (PV) devices that convert sunlight directly into electrical power. PV devices typically have one or more p-n junctions. Each junction comprises two different regions within a semiconductor material where one side is denoted as the p-type region and the other as the n-type region. When the p-n junction of the PV cell is exposed to sunlight (consisting of energy from photons), the sunlight is directly converted to electricity through the PV effect. PV solar cells generate a specific amount of electric power and cells are tiled into modules sized to deliver the desired amount of system power. PV modules are joined into panels with specific frames and connectors. The solar cells are commonly formed on a silicon substrate, which may be in form of single or multicrystalline silicon substrates. A typical PV cell includes a p type silicon wafer, substrate or sheet typically less than about 0.3 mm thick with a thin layer of n-type silicon on top of a p-type region formed in a substrate.

The photovoltaic market has experienced growth with annual growth rates exceeding above 30% for the last ten years. Some articles have suggested that solar cell power production world wide may exceed 10 GWp in the near future. It has been estimated that more than 95% of all photovoltaic modules are silicon wafer based. The high market growth rate in combination with the need to substantially reduce solar electricity costs has resulted in a number of serious challenges for inexpensively forming high quality photovoltaic devices. Therefore, one major component in making commercially viable solar cells lies in reducing the manufacturing costs required to form the solar cells by improving the device yield and increasing the substrate throughput.

Screen printing has long been used in printing designs on objects, such as cloth, and is used in the electronics industry for printing electrical component designs, such as electrical contacts or interconnects on the surface of a substrate. State of the art solar cell fabrication processes also use screen printing processes. Misaligned, or inaccurately placed, screen printed patterns on an electronic device or solar cell can affect the device yield. Moreover, the accuracy of the placement of the screen printed pattern on a solar cell substrate can affect the cost to produce a solar cell device and the cost of ownership of a solar cell production line.

Therefore, there is a need for a screen printing apparatus for the production of solar cells, electronic circuits or other useful devices that provides an accurate placement of a screen printed material to improve the device yield and produce a lower cost of ownership (CoO) than other known apparatuses.

### SUMMARY OF THE INVENTION

The present invention generally provide an apparatus for processing a substrate, comprising a material conveyor assembly comprising a platen having a substrate supporting surface, a first material positioning mechanism that is adapted to provide a supporting material to the substrate supporting surface, the supporting material having a first surface on which a plurality of features are formed, and a second material positioning mechanism that is adapted to receive the supporting material transferred across at least a portion of the substrate supporting surface from the first material positioning mechanism, a sensor assembly disposed over the first surface, wherein the sensor assembly is positioned to sense the change in position of the plurality of features formed on the first surface, and a controller adapted to receive a signal from the sensor assembly and control the position of the supporting material on the substrate supporting surface using an actuator coupled to the first material positioning mechanism or the second material positioning mechanism.

Embodiments of the invention further provide a method of processing a substrate, comprising receiving a substrate on a first surface of a support material, wherein the first surface has plurality of features formed thereon, moving the support material across a surface of a substrate support, sensing the movement of the plurality of features past a sensor assembly, and controlling the position of the substrate on the surface of the substrate support based at least partially on the sensed movement of the plurality of features.

Embodiments of the invention further provide a method of processing a substrate, comprising receiving a substrate on a first surface of a support material, wherein the first surface has plurality of features formed thereon, moving the support material across a surface of a substrate support, emitting electromagnetic radiation from a source onto the first surface of the support material, wherein the emitted radiation striking the first surface interacts with the plurality of features formed thereon, receiving an intensity of the electromagnetic radiation after the at least a portion of the electromagnetic radiation has interacted with the plurality of features, and monitoring the intensity of the received electromagnetic radiation to determine the position of the substrate on the surface of the substrate support.

Embodiments of the invention further provide a support material used to support a substrate during processing, comprising a material having a first surface, and a first end and a second end, a plurality of features formed on a region of the first surface which extends in a direction between the first end and second end, wherein the material a sufficient thickness in a direction substantially perpendicular to the first surface to allow a air to pass through the thickness when a vacuum is applied to a side opposite to the first side of the material. In one example, the plurality of features comprise an array of equally spaces lines formed on the first surface.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

FIG. 1 is an isometric view of a screen printing system according to one embodiment of the invention.

FIG. 2 is a plan view of the screen printing system illustrated in FIG. 1 according to one embodiment of the invention.

FIG. 3 is an isometric view of a rotary actuator assembly according to one embodiment of the invention.

FIG. 4 is an isometric view of a printing nest portion of the screen printing system according to one embodiment of the invention.

FIG. 5A is an isometric view of a printing nest according to one embodiment of the invention.

FIG. 5B is a close-up isometric view of a region of the printing nest illustrated in FIG. 5A according to one embodiment of the invention.

FIG. 6A is a side schematic cross-sectional view illustrating one embodiment of a printing nest according to one embodiment of the invention.

FIG. 6B is a side schematic cross-sectional view illustrating one embodiment of a printing nest according to one embodiment of the invention.

To facilitate understanding, identical reference numerals have been used, where possible, to designate identical elements that are common to the figures. It is contemplated that elements and features of one embodiment may be beneficially incorporated in other embodiments without further recitation.

It is to be noted, however, that the appended drawings illustrate only exemplary embodiments of this invention and are therefore not to be considered limiting of its scope, for the invention may admit to other equally effective embodiments.

### DETAILED DESCRIPTION

The present invention(s) provide an apparatus and method for processing substrates in a screen printing chamber that can deliver a repeatable and accurate screen printed pattern on one or more processed substrates. In one embodiment, the screen printing chamber is adapted to perform a screen printing process within a portion of a crystalline silicon solar cell production line in which a substrate is patterned with a desired material. In one embodiment, the screen printing chamber is a processing chamber positioned within the Rotary line tool or Softline™ tool available from Baccini S.p.A., which is owned by Applied Materials, Inc. of Santa Clara, Calif.

### Screen Printing System

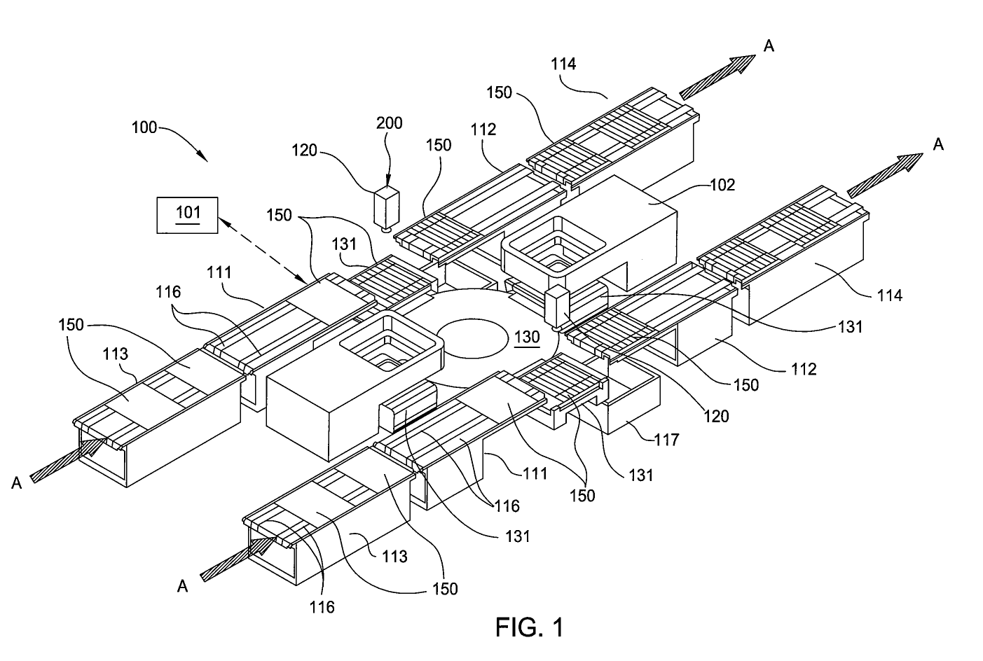

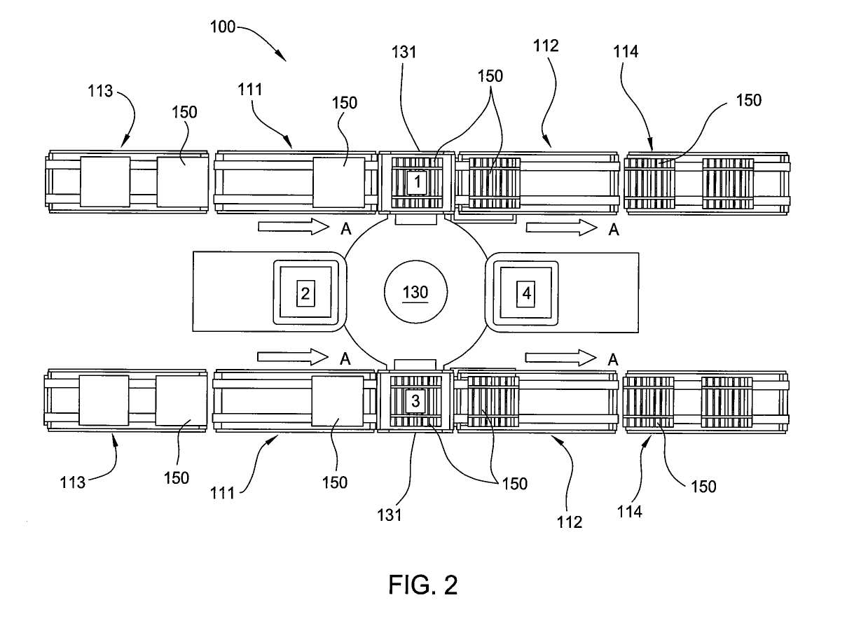

FIGS. 1-2 illustrate a multiple screen printing chamber processing system, or system 100, that may be used in conjunction with various embodiments of this invention. In one embodiment, the system 100 generally contains two incoming conveyors 111, a rotary actuator assembly 130, two screen printing heads 102, and two outgoing conveyors 112. Each of the two incoming conveyors 111 are configured in a parallel processing configuration so that they each can receive substrates from an input device, such as an input conveyor 113, and transfer the substrate to a printing nest 131 coupled to the rotary actuator assembly 130. Also, each of the outgoing conveyors 112 are configured to receive processed substrates from the printing nest 131 coupled to the rotary actuator assembly 130 and transfer each processed substrate to a substrate removal device, such as an exit conveyor 114. The input conveyor 113 and exit conveyor 114 are generally an automated substrate handling devices that are part of a larger production line, for example the Rotary line tool or the Softline™ tool, that is connected to the system 100. One will note that FIGS. 1-4 are only intended to illustrate one possible processing system configuration that could benefit from the various embodiments described herein, and thus other conveyor configurations and other types of material deposition chambers could be used without deviating from the basic scope of the invention described herein. Examples of other system configurations that may be adapted to benefit from one or more of the embodiments described herein are further described in the commonly assigned U.S. Pat. No. 6,595,134, filed Dec. 11, 2001, and the commonly assigned. U.S. patent application Ser. No. 11/590,500, filed Oct. 31, 2006, which are both incorporated by reference herein.

FIG. 2 is a plan view of the system 100 that schematically illustrates the position of the rotary actuator assembly 130 in which two of the printing nests 131 (e.g., reference numerals “1” and “3”) are oriented so that they can transfer a substrate 150 from each of the printing nests 131 to the outgoing conveyor 112 and each receive a substrate 150 from each of the incoming conveyors 111. The substrate motion thus generally follows the path “A” shown in FIGS. 1 and 2. In this configuration the other two printing nests 131 (e.g., reference numerals “2” and “4”) are oriented so that a screen printing process can be performed on the substrates 150 that are positioned within the two screen printing chambers (i.e., screen printing heads 102 in FIG. 1). Also, in this configuration, the printing nests 131 are oriented such that the direction of substrate movement on the nest is tangential to the rotary actuator assembly 130, which is different from other commercially available systems that have a radially oriented substrate movement. A tangential orientation of the conveyors to the rotary actuator assembly 130 allows the substrates to be delivered and received from two locations, for example reference numerals “1” and “3” (FIG. 2), without increasing the footprint of the system.

It is believed that when only one substrate is screen printed at a time, printing accuracy can remain very high, since the print head 102 only needs to be precisely aligned to a single substrate rather than two or more substrates at one time. This configuration thus is used to increase the system throughput and system uptime, without affecting the accuracy of the screen printing process.

The incoming conveyor 111 and outgoing conveyor 112 generally include at least one belt 116 that is able to support and transport the substrates 150 to a desired position within the system 100 by use of an actuator (not shown) that is in communication with the system controller 101. While FIGS. 1-2 generally illustrate a two belt 116 style substrate transferring system, other types of transferring mechanisms may be used to perform the same substrate transferring and positioning function(s) without varying from the basic scope of the invention.

The system controller 101 is generally designed to facilitate the control and automation of the overall system 100 and typically may include a central processing unit (CPU) (not shown), memory (not shown), and support circuits (or I/O) (not shown). The CPU may be one of any form of computer processors that are used in industrial settings for controlling various chamber processes and hardware (e.g., conveyors, detectors, motors, fluid delivery hardware, etc.) and monitor the system and chamber processes (e.g., substrate position, process time, detector signal, etc.). The memory is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits are also connected to the CPU for supporting the processor in a conventional manner. The support circuits may include cache, power supplies, clock circuits, input/output circuitry, subsystems, and the like. A program (or computer instructions) readable by the system controller 101 determines which tasks are performable on a substrate. Preferably, the program is software readable by the system controller 101, which includes code to generate and store at least substrate positional information, the sequence of movement of the various controlled components, substrate inspection system information, and any combination thereof.

The two screen print heads 102 utilized in the system 100 may be conventional screen printing heads available from Baccini S.p.A. which are adapted to deposit material in a desired pattern on the surface of a substrate positioned on a printing nest 131 during the screen printing process. In one embodiment, the screen print heads 102 are adapted deposit a metal containing or dielectric containing material on a solar cell substrate. In one example, the substrate is a solar cell substrate that has a width between about 125 mm and 156 mm in size and a length between about 70 mm and 156 mm.

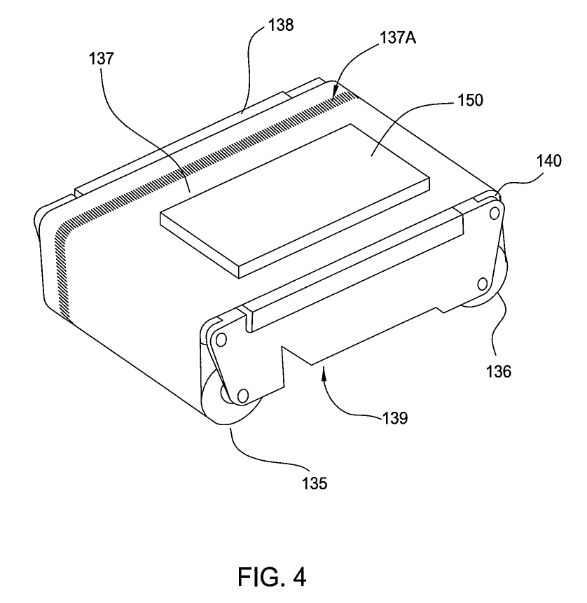

In one embodiment, the system 100 also contains an inspection assembly 200, which are adapted to inspect the substrates 150 before or after the screen printing process has been performed. The inspection assembly 200 may contain one or more cameras 120 that are positioned to inspect an incoming or processed substrate positioned in the positions “1” and “3,” as shown in FIGS. 1 and 2. The inspection assembly 200 generally contains at least one camera 120 (e.g., CCD camera) and other electronic components that are able to inspect and communicate the inspection results to the system controller 101 so that damaged or misprocessed substrates can be removed from the production line. The misprocessed substrates can be transferred by the printing nest 131 to a waste collection bin 117. In one embodiment, the printing nests 131 may each contain a lamp, or other similar optical radiation device, to illuminate a substrate 150 positioned over the support platen 138 (FIG. 4) so that it can be more easily inspected by an inspection assembly 200.

The inspection assembly 200 can also be used to determine the precise position of the substrates on each of the print nests 131. The location data of each substrate 150 on each printing nest 131 can be used by the system controller 101 to position and orient the screen print head components in the screen print head 102 to improve the accuracy of the subsequent screen printing process. In this case the position of each of the print heads can be automatically adjusted to align the screen print head 102 to the exact position of the substrate positioned on the print nest 131 based on the data received during inspection process step(s).

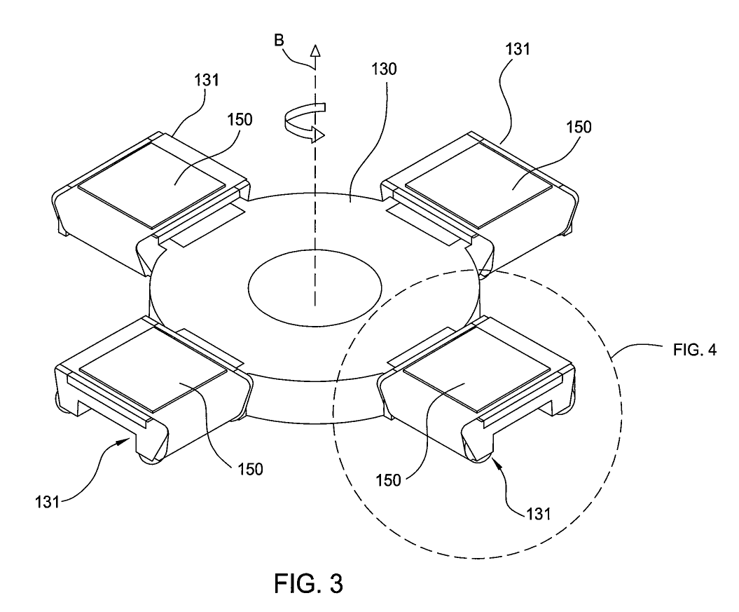

In one embodiment, as shown in FIGS. 1-3, the rotary actuator assembly 130 contains four printing nests 131 that are each adapted to support a substrate 150 during the screen printing process performed within each of the screen print heads 102. FIG. 3 is an isometric view of the rotary actuator assembly 130 that illustrates a configuration in which a substrate 150 disposed on each of the four printing nests 131. The rotary actuator assembly 130 can be rotated and angularly positioned about the axis “B” by the use of a rotary actuator (not shown) and the system controller 101 so that the printing nests 131 can be desirably positioned within the system. The rotary actuator assembly 130 may also have one or more supporting components that facilitate the control of the printing nests 131 or other automated devices that are used to perform a substrate processing sequence in the system 100.

### Printing Nest Configuration

As illustrated in FIG. 4, each printing nest 131 generally consist of a conveyor assembly 139 that has a feed spool 135, a take-up spool 136, and one or more actuators (not shown), which are coupled to the feed spool 135 and/or take-up spool 136, that are adapted to feed and retain a supporting material 137 positioned across a platen 138. The platen 138 generally has a substrate supporting surface on which the substrate 150 and supporting material 137 are positioned during the screen printing process performed in the screen print head 102. In one embodiment, the supporting material 137 is a porous material that allows a substrate 150, which is disposed on one side of the supporting material 137, to be retained on the platen 138 by a vacuum applied to the opposing side of the supporting material 137 by a conventional vacuum generating device (e.g., vacuum pump, vacuum ejector). In one embodiment, a vacuum is applied to vacuum ports (not shown) formed in the substrate supporting surface 138A of the platen 138 so that the substrate can be “chucked” to the substrate supporting surface 138A of the platen. In one embodiment, the supporting material 137 is a transpirable material that consists, for instance, of a transpirable paper of the type used for cigarettes or another analogous material, such as a plastic or textile material that performs the same function. In one example, the supporting material 137 is a cigarette paper that does not contain benzene lines.

In one configuration, a nest drive mechanism 148 that is coupled to, or is adapted to engage with, the feed spool 135 and a take-up spool 136 so that the movement of a substrate 150 positioned on the supporting material 137 can be accurately controlled within the printing nest 131. In one embodiment, feed spool 135 and the take-up spool 136 are each adapted to receive opposing ends of a length of the supporting material 137. In one embodiment, the nest drive mechanism 148 contains one or more drive wheels 147 that are coupled to, or in contact with, the surface of the supporting material 137 positioned on the feed spool 135 and/or the take-up spool 136 to control the motion and position of the supporting material 137 across the platen 138.

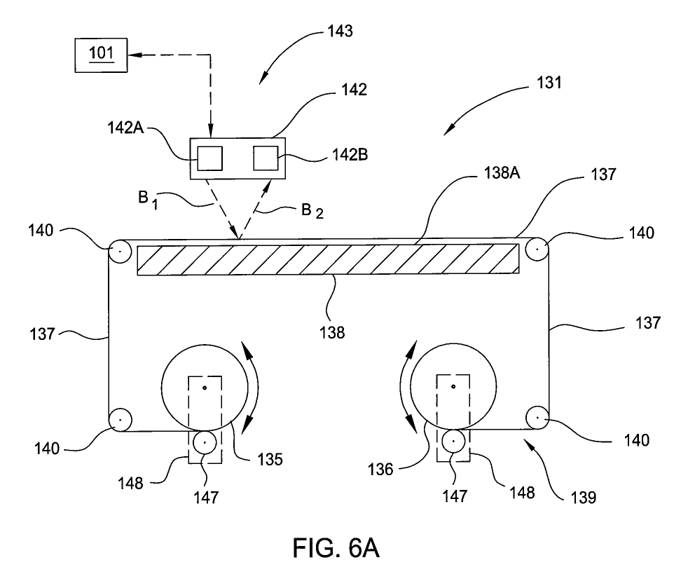

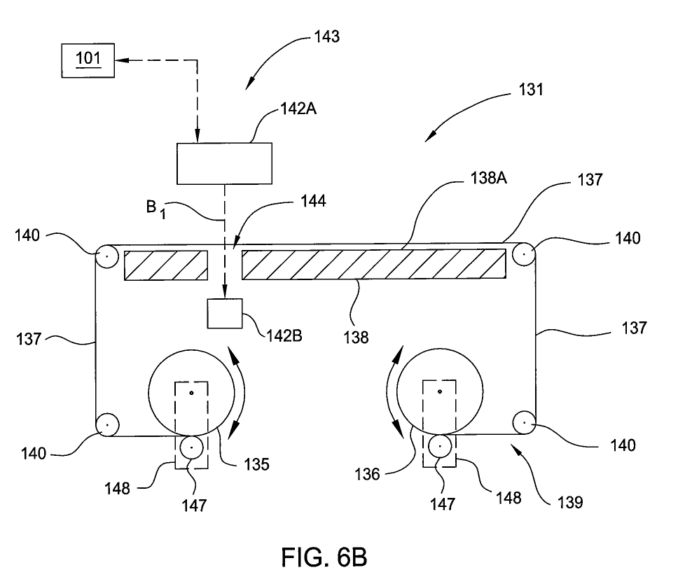

FIG. 6A is a side schematic cross-sectional view illustrating one embodiment of a conveyor assembly 139 in a printing nest 131. In this configuration the tension and motion of the supporting material 137 across the platen 138 is controlled by conventional actuators (not shown) in the nest drive mechanism 148 that are able to control the rotational movement of the feed spool 135 and/or the take-up spool 136. In one embodiment as shown in FIG. 6A, the supporting material 137 is guided and supported by a plurality of pulleys 140 as it is moved in either direction between the feed spool 135 and the take-up spool 136.

One issue that arises in the transfer and positioning of substrates using a roll-to-roll type conveyor system as shown in FIGS. 4 and 6A-6B is that the amount of supporting material 137 that is moved across the platen 138 due to the angular movement of the feed spool 135 or take-up spool 136 may vary thus affecting the system controller's ability to accurately and repeatably move a substrate disposed on the supporting material 137 to a desired processing position on the platen 138. The variation in the actual position of a substrate on the platen 138 creates a need for a camera 120 in the inspection assembly 200 that has a field of view larger than what would be necessary to assure that all areas of a desirably aligned substrate 150 and camera 120 are viewed during the inspection process. Therefore, since the resolution of the camera is inversely related to the size of the field of view the ability of the inspection system to detect defects on the substrates and determine the substrate's position on the platen 138 is often worse than is desired. Therefore, to improve the inspection process it is desirable to minimize the variation in the processing position of substrates disposed on the platen 138 to allow a higher resolution camera to be used to better detect defects to improve device yield and the cost of ownership of the screen printing process.

One possible cause of variation in the position of the substrate on the supporting material 137 on the platen 138 can be caused by slippage between the actuating devices and the spool of supporting material 137 positioned on the feed spool 135 or the take-up spool 136. To account for the variation in movement of supporting material 137 across the platen 138 it is possible to measure the diameter, or change in diameter, of one or more of the spools (e.g., feed spool 135 or the take-up spool 136). Alternately, it is possible to monitor the linear motion of the supporting material 137 by monitoring the rotation of one or more of the pulleys 140 or other similar supporting material 137 engaging devices. However, due to the general inaccuracy of these techniques and the possible slippage between the material engaging components (e.g., drive wheels 147, pulleys 140) the positioning accuracy of a substrate on the surface of the platen 138 generally will not meet today's or future production needs. Another possible cause of the variation using these techniques is the variation in the amount of supporting material 137 that is transferred across the platen 138 per rotation of the driven feed spool 135 or the take-up spool 136 as material is transferred from one spool to another during processing. In one example, if the motion of the material across the platen 138 is controlled by the rotational motion of the take-up spool 136 then the movement of the material across the platen 138 is affected by the diameter, or amount, of supporting material 137 wound around the take-up spool 136. Thus, the amount of supporting material 137 that passes linearly across the platen 138 will vary when the most of the supporting material 137 is wound around the feed spool 135 versus when the supporting material 137 is wound around the take-up spool 136. Therefore, there is a need for a more direct measurement technique that is able to measure and feedback the supporting material 137 movement or position data to the system controller 101 so that the movement and position of a substrate disposed thereon can be more accurately controlled. The improved accuracy can allow a higher resolution camera 120 (FIG. 1) to be used to detect defects in the incoming and/or outgoing substrates that are processed in the system 100. The higher resolution camera can help to reduce the number of misprocessed substrates and improve the device yield.

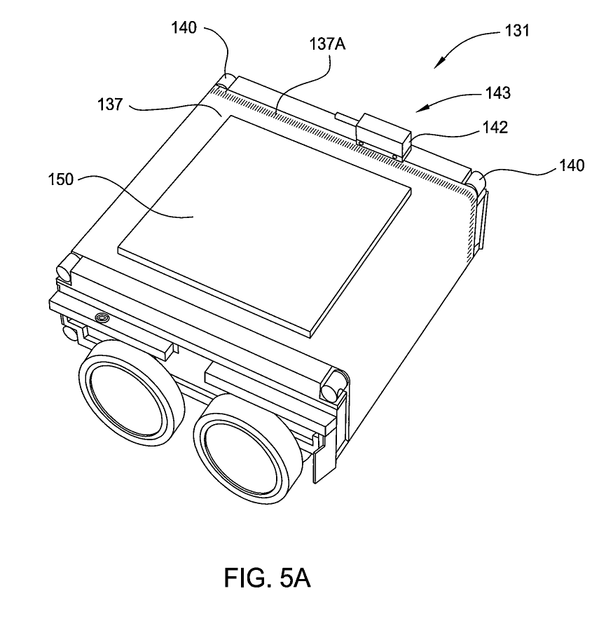

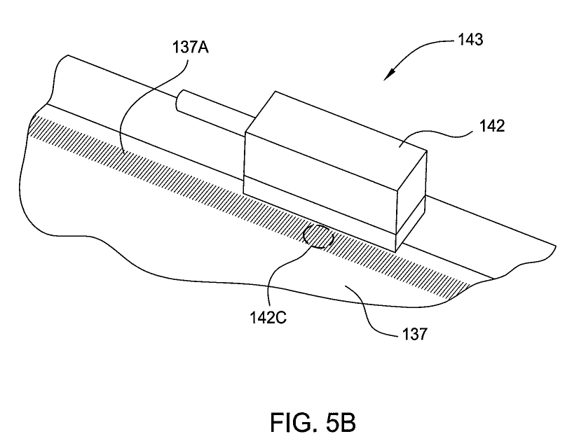

Moreover, it is believed that by directly monitoring the movement of the supporting material 137, the substrate can be conveyed at higher speeds to improve the system throughput. Higher substrate transfer speeds are generally achievable, since the increased likelihood that slippage between the supporting material 137 and the other conveyor assembly 139 components, due to the higher velocities or accelerations of the supporting material 137, will not affect the accuracy and control of the supporting material 137 and substrate 150 (FIG. 5A) position on the platen 138.

FIGS. 5A-5B and 6A-6B illustrate a printing nest 131 that contains a detection system 143 that is used to monitor and feedback the supporting material 137 movement and position data to the system controller 101. In general, the movement and position of the supporting material 137 can be monitored by use of a sensor assembly 142 in the detection system 143 that is positioned to view one or more regions of the supporting material 137 that has a pattern 137A formed thereon. The pattern 137A of formed elements may include a regular pattern of deposited material or formed features that can be detected by the sensor assembly 142 as it passes through a detection region 142C of the sensor assembly 142 (FIG. 5B). In one example, the pattern 137A is a regular array of printed ink lines that are deposited on the surface of the supporting material 137. In another example, the pattern 137A is an array of embossed features in the support material 137. In yet another example, the pattern 137A is an array of regions of removed support material 137, such as holes. The term holes as used herein may include but is not limited to round holes, oval holes, polygon shaped holes, slots, grooves, cuts or other similar feature that are formed in the support material 137.

FIG. 5A is an isometric view of a printing nest 131 that illustrates one embodiment of a pattern 137A formed on one edge of the supporting material 137 and inspected by the detection system 143. FIG. 5B is a close-up isometric view of the sensor assembly 142 and pattern 137A formed on the supporting material 137. In one embodiment, as shown in FIGS. 5A-5B, the pattern 137A comprises an array of equally spaced features (e.g., lines) that are disposed on or formed in the supporting material 137 that passes through and are sensed by the components in the sensor assembly 142.

The sensor assembly 142 generally contains one or more components that are able monitor the movement of the pattern 137A as it is moved by the components in the conveyor assembly 139. The sensor assembly 142 may utilize optical monitoring techniques, capacitive measurement technique, eddy current measurement techniques, or other similar suitable technique that is able to detect the motion of a pattern 137A or features within the pattern 137A as it passes by the sensor assembly 142. In one embodiment, the sensor assembly 142 includes a light source 142A and a detector 142B that are connected to the system controller 101. Typically, the light source 142A generally contains a source of some form of electromagnetic energy, such as light delivered from an LED or a laser that is directed at the surface of the supporting material 137. Typically, the detector 142B is conventional optical detector, such as a photoconductive sensor, thermoelectric detector, AC type optical sensor, DC type optical sensor, or other similar device that is adapted to detect the variation in intensity of the energy delivered by the light source 142A due to the interaction of the energy with the features within pattern 137A.

In one embodiment, each printing nest 131 contains two or more sensor assemblies 142 that are each positioned to detect the motion of the pattern 137A, and are used in combination with the system controller 101 to determine the actual motion of the supporting material 137. In one configuration, the two or more sensor assemblies 142 are positioned to monitor different portions of the pattern 137A so that the actual position can be determined.

In one configuration, the shape or one or more materials in the formed pattern 137A preferentially absorbs or reflects one or more wavelengths of light delivered from the light source 142A that is sensed by the detector 142B. In one case, an array of equally spaced lines of an ink material are deposited on a surface of the support material 137 which is seen as a series of signal intensity peaks and valleys by the detector 142B and system controller 101 as the pattern 137A is moved past the sensor assembly 142. The system controller 101 may use the intensity peaks and valley information to determine how much support material 137 has been moved past the sensor assembly 142 or determine the actual position of a portion of the support material 137. In some cases the shape of the features within the pattern 137A may change from one region of the roll of support material 137 to another (i.e., start of the roll of support material to the end of the roll), thus providing some information about the actual position of a region of the support material 137 on the roll. One skilled in the art will appreciate that any known shaped or spaced pattern 137A could be used to provide information to the system controller 101 about the supporting material and substrate movement without deviating from the basic scope of the invention described herein. Similarly, by positioning the sensor assembly 142 to view at least a portion of the surface of the substrate 150, one or more features on the substrate 150 could also be used by the sensor assembly 142 and system controller 101 to help control the position and/or movement of the substrate and supporting material.

FIG. 6A is a side cross-sectional view of the printing nest 131 that illustrates one embodiment of the sensor assembly 142 that uses reflected energy to monitor the movement of the supporting material 137. In this configuration, the sensor assembly 142 generally consists of a light source 142A that illuminates “B1” the detection region 142C (FIG. 5B) on the supporting material 137 containing the pattern 137A and receives an amount of reflected light “B2” at the detector 142B that is altered by the interference or interaction with the pattern 137A. The altered energy received by the detector 142B due to the interaction with the pattern 137A is fed back to the system controller 101 so that the movement and/or position of supporting material 137 can be controlled. In one case the electromagnetic energy delivered by the light source 142A is designed to preferentially reflect from the surface of the supporting material 137 or the material from which that the pattern 137A is formed, so that the movement of the pattern 137A can be monitored by the system controller 101. In another embodiment, the electromagnetic energy delivered by the light source 142A is reflected off of the platen 138, and thus the presence or absence of the supporting material 137 in the pattern 137A is used to monitor the movement and/or position of the supporting material 137. In yet another embodiment, the electromagnetic energy delivered by the light source 142A is primarily reflected off of the platen 138 due to the opaque nature of the supporting material 137, and thus the presence and absence of a material in the pattern 137A (e.g., deposited ink regions) formed on the supporting material 137 surface is used to alter the reflected energy and thus provide information about the movement of the supporting material 137 past the sensor assembly 142. In an alternate configuration, the sensor assembly 142 is positioned beneath the platen 138, such as within the printing nest 131. In this case, the pattern 137A formed on a surface of the supporting material 137 may be viewed through a hole (not shown) formed in the platen 138.

FIG. 6B is a side cross-sectional view of the printing nest 131 that illustrates one embodiment of the sensor assembly 142 that uses through-beam sensor configuration to monitor the movement of the supporting material 137. In this configuration, the sensor assembly 142 generally consists of a light source 142A that is positioned to provide light to a detector 142B that is disposed on the opposite side of supporting material 137. Therefore, the interference or interaction of the energy delivered by the light source 142A with the pattern 137A is received by the detector 142B so that the movement and/or position of the material can be controlled. In one embodiment, the electromagnetic energy delivered by the light source 142A is passed through an array of holes in the in the supporting material 137, and thus the presence or absence of the supporting material 137 in the pattern 137A is used to monitor the movement and/or position of the supporting material 137. In another embodiment, the electromagnetic energy delivered by the light source 142A primarily passes through the supporting material 137, and thus the presence of a material in the pattern 137A (e.g., ink) is used to alter the energy received by the detector 142B to help provide information about the movement of the supporting material 137. In one embodiment, the light is light source 142A delivers light through a hole 144 formed in the platen 138.

While the foregoing is directed to embodiments of the present invention, other and further embodiments of the invention may be devised without departing from the basic scope thereof, and the scope thereof is determined by the claims that follow.

1. An apparatus for processing a substrate, comprising:
a material conveyor assembly comprising:
a platen having a substrate supporting surface;
a first material positioning mechanism that is adapted to provide a supporting material to the substrate supporting surface;
the supporting material having a first surface on which a plurality of features are formed; and
a second material positioning mechanism that is adapted to receive the supporting material transferred across at least a portion of the substrate supporting surface from the first material positioning mechanism;
one or more sensor assemblies disposed over the first surface, wherein the one or more sensor assemblies are positioned to sense the change in position of the plurality of features formed on the first surface; and
a controller adapted to receive a signal from the one or more sensor assemblies and control the position of the supporting material on the substrate supporting surface using an actuator coupled to the first material positioning mechanism or the second material positioning mechanism.

2. The apparatus of claim 1, wherein each of the one or more sensor assemblies further comprise:
an electromagnetic radiation source that is mounted proximate to the first surface of the supporting material and is adapted to emit electromagnetic radiation;
a detector that is mounted proximate to the first surface of the supporting material and is adapted to detect the variation of intensity of the electromagnetic radiation delivered from the electromagnetic radiation source after interacting with plurality of features formed on the first surface; and
a controller adapted to receive a signal from the detector and control the position of the supporting material on the substrate supporting surface.

3. The apparatus of claim 1, further comprising an inspection system comprising a first camera which is positioned to monitor a substrate disposed on the first surface of the supporting material, wherein the controller is adapted to position the substrate based on information received by the inspection system.

4. The apparatus of claim 1, wherein the supporting material is a continuous sheet of material that has one end coupled to the first material positioning mechanism and the opposing end coupled to the second material positioning mechanism.

5. The apparatus of claim 1, further comprising a conveyor that comprises at least one belt and a conveyor actuator coupled to the at least one belt, wherein the conveyor is positioned to transfer a substrate disposed on the at least one belt to the first surface of the supporting material.

6. The apparatus of claim 1, wherein the plurality of features includes pattern of regularly spaced regions of deposited material or holes within the supporting material.

7. The apparatus of claim 1, wherein each of the one or more sensor assemblies comprise a capacitive type sensor, an optical measurement sensor, or an eddy current measurement sensor.

8. A method of processing a substrate, comprising:
receiving a substrate on a first surface of a support material, wherein the first surface has plurality of features formed thereon;
moving the support material across a surface of a substrate support;
sensing the movement of the plurality of features past a sensor assembly; and
controlling the position of the substrate on the surface of the substrate support based at least partially on the data received from the sensed movement of the plurality of features.

9. The method of claim 8, further comprising:
receiving the substrate on a first conveyor;
transferring the substrate from the first conveyor to the support material during the receiving the substrate on the first surface of the support material;
halting the moving support material across the surface of the substrate support when the substrate is in a first position; and
evacuating a region behind a second surface of the support material to hold the substrate disposed on the first surface to retain the substrate in the first position.

10. The method of claim 8, further comprising:
positioning the substrate in a screen printing chamber after controlling the position of the substrate on the surface of the substrate support; and
depositing a material on the substrate disposed in the screen printing chamber.

11. The method of claim 8, wherein sensing the movement of the plurality of features comprises:
emitting electromagnetic radiation from a source onto the first surface of the support material, wherein the emitted radiation interacts with the plurality of features formed thereon;
receiving an intensity of the electromagnetic radiation after the at least a portion of the electromagnetic radiation has interacted with the plurality of features; and
monitoring the intensity of the received electromagnetic radiation to determine the position of the substrate on the surface of the substrate support.

12. The method of claim 7, wherein sensing the movement of the plurality of features comprises using a capacitive type sensor, an optical measurement sensor, or an eddy current sensor.

13. A method of processing a substrate, comprising:
receiving a substrate on a first surface of a support material, wherein the first surface has plurality of features formed thereon;
moving the support material across a surface of a substrate support using an actuator coupled to the supporting material;
emitting electromagnetic radiation from a source onto the first surface of the support material, wherein the emitted radiation striking the first surface interacts with the plurality of features formed thereon;
receiving an intensity of the electromagnetic radiation after the at least a portion of the electromagnetic radiation has interacted with the plurality of features; and
monitoring the intensity of the received electromagnetic radiation to determine the position of the substrate on the surface of the substrate support.

14. The method of claim 13, further comprising inspecting a first substrate disposed in the first position on the substrate support.

15. The method of claim 13, further comprising controlling the position of the substrate on the surface of the substrate support based at least partially on the data received from monitoring the intensity of the received electromagnetic radiation.

16. The method of claim 15, further comprising:
positioning the substrate in a screen printing chamber after controlling the position of the substrate; and
depositing a material on the substrate disposed on the substrate support using a screen printing process.

17. A support material used to support a substrate during processing, comprising:
a material having a first surface, and a first end and a second end;
a plurality of features formed on a region of the first surface which extends in a direction between the first end and second end,
wherein the material a sufficient thickness in a direction substantially perpendicular to the first surface to allow a air to pass through the thickness when a vacuum is applied to a side opposite to the first side of the material.

18. The support material of claim 17, wherein the plurality of features comprise an array of equally spaced lines.
